(19) United States
(12) Patent Application Publication
(10) Pub. No.: US 2006/0272312 A1
(43) Pub. Date: Dec. 7, 2006

(54) Rotating Burner Outlet Turbine (RBOT) split rotary combustion chamber engine

(76) Inventor: Mitchel Joseph Matovich JR., La Jolla, CA (US)

Correspondence Address: Mitchel J. Matovich, Jr., 7068 Neptune Place, La Jolla, CA, 92037, US

(21) Appl. No.: 11/141,131

(22) Filed: Jun. 1, 2005

(51) Int. Cl. F02C 3/16

(52) U.S. Cl. 60/39.35

(57) ABSTRACT

A gas turbine engine with a split wall, (one wall fixed and one wall free to rotate) annular combustion chamber. The rotating wall of said combustion chamber has vanes or jets affixed around its outer periphery that are canted in such a manner as to cause the reactive force of the escaping gas to rotate that wall of said combustion chamber. The gas then proceeds to impinge on the blades of a turbine wheel driving it in the opposite direction. The two counter-rotating bodies are then coupled to the shaft that drives the compressor stage of the turbine. Said configuration permits operation with higher gas temperatures within the burner which result in higher gas output velocities resulting in efficiency in fuel consumption and relatively clean emissions. The higher output velocities are made possible because the rotation of the gas output nozzles/vanes reduce the velocity of the gas impinging on the turbine blades by the velocity of the nozzles/vanes moving in the opposite direction.

### FIELD OF INVENTION

This invention relates to fuel fired turbine engines and more specifically to turbine engines with rotating combustion chambers.

### DISCUSSION OF THE PRIOR ART

A typical gas turbine engine has combustion chambers where fuel is injected into air fed from a compressor stage and ignited. The burned gas is then directed onto the blades of a turbine wheel. The efficiency of these turbines is limited by the temperatures and velocities of the output gas which are imposed by the thermal and mechanical capabilities of the turbine blades. Prior art, notably that described in U.S. Pat. No. 3,557,551 entitled Gas Turbine Engine With Rotating Combustion Chamber by G. K. C. Campbell describes the advantages of a rotating combustion chamber beautifully but fails to implement the concept as a practical machine. The inventor could not find any other prior art that solves the principle problems faced by the Campbell design including pressure seals, high rotational weight and rotating fuel supply system. The invention described herein does so with a radically new approach to combustion chamber configuration.

### BACKGROUND OF THE INVENTION

Gas turbine engines typically utilize stationary combustion chambers where fuel is injected into air that is fed from a compressor stage and ignited. The burned gas is then directed through nozzles onto the blades of a turbine wheel that is connected to the power shaft. The efficiency of such turbines is limited by the allowable temperatures and velocities of the output gas. These limitations are imposed by the thermal and mechanical capabilities of the turbine blades which are subject to failure when specific limits have been exceeded.

Prior art such as described in U.S. Pat. No. 3,009,319 entitled Turbojet Engine by G. D. Filipenco used a rotating combustion chamber but lacked efficiency. U.S. Pat. No. 3,557,551 entitled Gas Turbine Engine With Rotating Combustion Chamber by G. K. C. Campbell describes the advantages of a rotating combustion beautifully but fails to implement the concept as a practical machine. The Campbell design and iterations of that design, contain features that would make sealing of the pressurized intake air difficult if not impossible and the rotating of the combustion chamber(s) and the fuel supply assemblies at turbine velocities (rotational speeds of well over 10,000 rpm) would create material stress and balance problems that would make its implementation impractical, even if the fuel feed/flow problems could be solved. (At those rotational velocities a bubble in a fuel line could cause a serious imbalance.)

The invention described herein offers a way of configuring the combustion chamber that eliminates these problems by reducing the rotating weight, eliminating the need for input air seals and allowing the fuel system to be mounted in a fixed position.

### OBJECTS AND SUMMARY OF THE INVENTION

One object of the present invention is to provide a gas turbine of high efficiency. Another object is to provide a gas turbine engine with a high power to weight ratio. Another object is to provide a gas turbine engine of high power to total air intake ratio. Another object is to provide a gas turbine engine with cleaner than normal emissions. Another object is to provide a gas turbine engine that can burn “dirty” fuels.

The disclosed invention is a gas turbine engine that utilizes the reactive force of the high velocity gas jet from the output of the burner to obtain high efficiency and power, and accomplishes this using existing, available materials which have limited temperature and stress capabilities. The combustion chamber is annular in configuration and split with one wall being a rotating wheel with vanes or nozzles mounted around the periphery of its output rim. Altering the shape of the combustion chamber will not alter the novelty or uniqueness of the split wall concept. (The interior wall configuration of the burner and cooling air methodology is neither novel nor new so is not described herein.) The vanes or nozzles direct the burned gasses at an angle that will result in the escaping gas acting as a series of rockets to propel that wall of the combustion chamber into rotation.

Because the opposite wall of the combustion chamber is stationary the configuration reduces the rotational weight and permits the use of a stationary fuel supply system containing no rotating joints.

After being expelled from the combustion chamber and through the vanes, or jets, the flow of high velocity gas then strikes the blades of the turbine wheel driving it into rotation in the opposite direction. Allowing the combustion chamber wheel to rotate allows the use of very high gas velocities because the velocity at which the gas strikes the turbine blade wheel is reduced by the velocity of the combustion chamber wheel turning in the opposite direction.

Both the turbine wheel and the combustion chamber wheel provide power to the engine output shaft.

The power added by the rotation of the combustion chamber wheel results in a much greater power output for an engine of given size and weight.

Higher gas velocities are attainable with less excess air allowing for a relatively small compressor stage.

The compressor stage may be either axial or centrifugal and contain any practical number of stages and the output stage, beyond the first turbine wheel, may contain multiple turbine wheels.

### BRIEF DESCRIPTION OF THE DRAWINGS

FIG. 1 is a front/side view of a gas turbine engine that utilizes a three stage centrifugal compressor intake stage 2, a split wall 4 and 5 burner stage 3 a first stage turbine wheel 7 with turbine blades mounted around its outer periphery 8 a set of stationary blades 9 mounted in a manner as to direct the flow of gas to the second stage turbine wheel 10 and the vanes 11 mounted to its periphery. After passing over the vanes of the second turbine wheel 11 the gas then passes over a set of exhaust blades 12 which smooth its flow towards the exhaust 13.

FIG. 2 is a half section view of the engine as described in FIG. 1.

### DESCRIPTION OF THE PREFERRED EMBODIMENTS

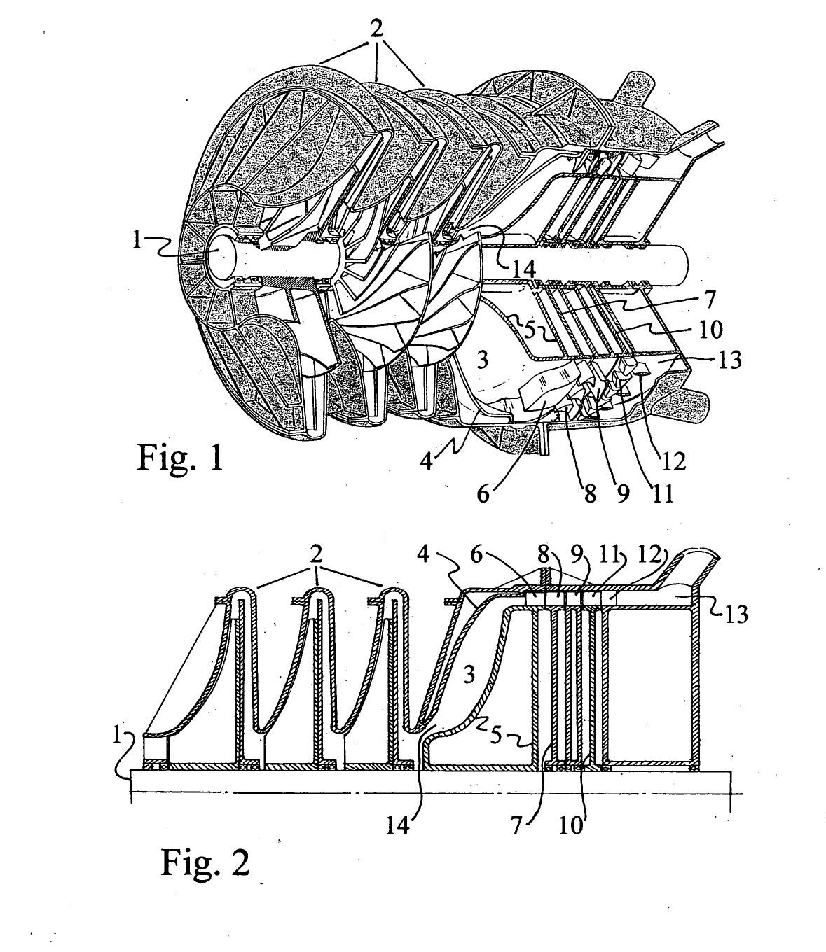

FIG. 1 illustrates a gas turbine engine which is comprised of a compressor stage 2 (In this case the compressor is a three stage centrifugal compressor) which compresses the air and exhausts the compressed air into the split wall, annular burner 3 where fuel is introduced and ignited near the throat of the burner 14 creating a hot high pressure gas. The fuel and ignition systems are public domain and are not described herein. The combustion chamber is annular in configuration and split, with one wall 4 being stationary and the other wall 5 being a rotating wheel with vanes or nozzles 6 mounted around the periphery of its output rim. These vanes or nozzles direct the burned gasses at an angle that has a significant component in the direction of rotation that will propel that wall of the combustion chamber into rotation. This flow of high velocity gas then strikes the blades 8 of the first stage turbine wheel 7 driving it in the opposite direction. After passing over the blades of the first stage turbine wheel the gas flow is smoothed and directed by stationary turbine blades 9 into the blades 11 of the second stage turbine wheel 10. After passing from the blades of the second turbine wheel, the flow of the gas is smoothed and directed into the exhaust chamber. The combustion chamber wheel 5, the first stage turbine wheel 7 and the second stage turbine wheel are coupled to the power output shaft either directly or through gears or other suitable power transmission mechanism.

The input compressed air that supplies the combustion chamber may be supplied through a centrifugal compressor as shown or one with any number of stages or it may be supplied by an axial compressor stage.

### References Cited

### United States Patents

| | | | |
|---|---|---|---|
| 2,710,067 | June 1995 | Pesaro | 60/39.35X |
| 2,900,789 | August 1959 | Philpot | 60/270X |
| 3,321,911 | May 1967 | Myles | 60/39.35 |
| 3,371,718 | March 1968 | Bacon | 60/39.35 |
| 4,006,591 | February 1977 | Cervenka | 60/39.5 |
| 4,368,619 | January 1983 | Levesque | 60/39.5 |
| 5,372,005 | December 1994 | Lawler | 60/39.5 |
| 5,660,038 | July 1997 | Stone | 60/39.5 |
| 6,347,507 | February 2002 | Lawlor | 60/39.5 |

What is claimed is:

1. An engine comprising:
an engine housing;
an annular split wall combustion chamber mounted within that housing;
a stationary wall and rotatably mounted wall of the combustion chamber;
nozzles or vanes affixed to the outer periphery of the rotatably mounted wall of the . . . combustion chamber for exhausting a gas in a direction to rotate said wall;

2. An engine comprising: an engine housing;
an axial or centrifugal compressor mounted within that housing;
an annular split wall combustion chamber mounted within that housing;
a stationary wall and rotatably mounted wall of the combustion chamber;
nozzles or vanes affixed to the outer periphery of the rotatably mounted wall of the . . . combustion chamber for exhausting a gas in a direction to rotate said wall; a turbine . . . blade wheel mounted adjacent to, and on the same center of rotation as, the rotatably . . . mounted combustion chamber wall to receive gas jet directly from nozzles vanes or . . . jets mounted to the rotating combustion chamber wall.
